(19) United States
(12) Patent Application Publication
(10) Pub. No.: US 2013/0213996 A1
(43) Pub. Date: Aug. 22, 2013

(54) The Turn Up

(71) Applicant: Ravi Ramcharan, Hialeah, FL (US)

(72) Inventor: Ravi Ramcharan, Hialeah, FL (US)

(21) Appl. No.: 13/769,426

(22) Filed: Feb. 18, 2013

Related U.S. Application Data
(60) Provisional application No. 61/600,908, filed on Feb. 20, 2012.

(51) Int. Cl. G07F 11/14

(52) U.S. Cl. CPC G07F 11/14
USPC 221/262

(57) ABSTRACT

The unique technology displayed in The Turn Up container assembly is the linear movement of contents inside of a container, when they are in liquid form. By rotating the container the contents are moved proportionately from the bottom to the open top end, enabling easier access to them. This movement is uniquely provided by the gradual decompression of an initially compressed conical compression spring. The gradual uncompressing of the spring is used to provide controlled linear movement of a platform, which is what the contents rest upon inside the container. By pushing up on this platform while its edges are in contact with the inside walls of the container, a watertight seal above and below the platform is maintained, enabling the use of liquid based products inside the container. The spring is initially contained between two flat surfaces, the bottom of the container, and a snap on bottom section of the assembly. The bottom of the container has a small cutout in it, enabling the spring to be exposed into the container, below the platform. The lower end of the spring is fixed within the bottom housing forcing the upper end of the spring to rotate when the bottom housing is rotated. This rotation of the spring gradually decompresses it therefore releasing its potential energy and in turn moving the contents up.

### CROSS-REFERENCE TO RELATED APPLICATIONS

Provisional application—application No: 61/600,908

Provisional application—date of file: Feb. 20, 2012

This is the non-provisional application for a utility patent for “The Turn Up”. It is being made during the 12-month pendency period of the provisional application for “The Turn-Up”.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The Turn Up is a container assembly which allows the consumer to move the contents upward as they get low in the container. The concept is that as the container's turned separate from the base that it's connected to, the contents inside move upward allowing easy access at all times, while keeping food off of the consumer's hands.

Prior to The Turn Up no container has been able to provide linear motion of its contents while maintaining a watertight seal inside. This watertight seal is vital to ensuring liquid contents don't leak out of the bottom of the container when stored, or in use. The Turn Up enables this watertight linear motion through the use of a gradually uncompressed spring. By use of his gradually uncompressed spring a platform is pushed upwards during operation, which the contents rest upon inside the container. By pushing the platform from the bottom (instead of it moving along a track) a watertight seal is maintained at all times. The Turn Up also ensures there is no material protruding into the section of the container where the contents are stored, this enables the contents to be scooped out of the container.

The field of endeavor to which The Turn Up pertains would be food containers and packaging as it will primarily be used for containment and dispensing of food products such as but not limited to condiments and dips.

### PRIOR ART SEARCH

The keywords used in this prior art search include: food, container, dispenser, and spring.

The keywords and combinations thereof were entered into the following search engines and databases: www.uspto.gov, www.surfip.gov.sg, www.westlaw.com, ep.espacenet.com.

Prior art which may be of most concern with respect to novelty and non-obviousness are the following items listed below: 1, 2, 3, 6, and 7.

Summary of the Patent and Patent Application Search:

1. Patent on food dispenser with bottom that moves up with a screw mechanism.
2. Patent on deodorant dispenser with bottom that moves up with screw mechanism.
3. Patent on a butter dispenser with a bottom that moves with a screw mechanism.
4. Patent on a food dispenser whose mechanism includes a spring.
5. Patent on the Original propel-repel type dispenser.

Summary of the Journal and General Publication Search:

6. Online instructions on how to convert deodorant container to food spreading device.

Summary of the Marketing and Business Search:

7. Food gun manufacturer.

### US PATENTS

(Note: Each patent abstract's main differences are highlighted in red. The patent is also followed by a comparison with my product The Turn Up.)
1. Patent on food dispenser with bottom that moves up with a screw in mechanism.

U.S. Pat. No. 6,932,530: Spreadable food dispenser

Filing Date: Jul. 31, 2003

Patent Assignee: none

http://patft1.uspto.gov/netacgi/nph-Parser?patentnumber=6932530

### Abstract

A container for dispensing a spreadable food product consists of a housing, a platform positioned within the housing for supporting the spreadable food product, a dispensing mechanism mounted in the housing and attached to the platform for moving the platform from the bottom end of the housing towards the open top end of the housing along an axis for dispensing the spreadable food product, and a cover for covering the housing when not in use. The top end may be of convex, concave, slotted or other shapes and designs.

Differences from My Product:

My container does not have a dispensing mechanism attached to the platform and does not work with a screw mechanism. Instead, the platform rests on top of a spring and is pushed upward gradually by the spring. This upward motion is a result of gradually releasing the spring's potential energy by rotating the container.

By having the dispensing mechanism attached to the platform, or for the platform to move along a dispensing mechanism, a watertight seal cannot be achieved. With a screw based movement the gap between the threads cannot provide sealing between the upper and lower side of the platform. In order for the platform to move linearly along the axis this way there must be some type of penetration of the platform. The dispensing mechanism allows liquids to leak past the platform into the lower part of the container because there isn't a watertight seal between the platform and the screw mechanism. Also this screw mechanism would protrude above the platform at all times until the platform comes to its topmost point. This screw mechanism protruding upward would get in the way of “scooping” the contents out of the container.

With my product a spring is initially compressed within the bottom housing where its potential energy is stored. Through rotation this potential energy is released gradually providing linear movement with no penetration of the platform or cylinder walls therefore providing complete sealing of the upper part of the cylinder from the lower part, allowing liquids to be stored.

2. Patent on deodorant dispenser with bottom that moves up with screw mechanism,

U.S. Pat. No. 6,095,708: Refillable Deodorant Dispenser

Filing Date: Aug. 1, 2000

Patent Assignee: none

http://patft1.uspto.gov/netacgi/nph-Parser?patentnumber=6095708

### Abstract

A new refillable deodorant dispenser for reducing costs associated with deodorants and antiperspirants. The inventive device includes a generally cylindrical container that holds liquid deodorant therein and has an open upper end and a lower end. A roller ball is rotatably disposed in the container and protrudes from the upper end of the container. A cap portion has a closed upper end and an open lower end. The lower end of the cap portion is removably coupled to the upper end of the container. In one embodiment, the container has a collar portion that is removably coupled to a body portion. The roller ball is rotatably disposed in the collar portion. In another embodiment, a bottom lid is removably coupled to an open lower end of the container. In a third embodiment, the deodorant is a solid stick with a threaded channel in it disposed on a base portion with a threaded aperture extending through it. A lower cap portion is removably coupled to a lower end of the container. The lower cap portion has a threaded rod that extends through the base portion for raising the bottom portion with respect to the bottom end of the container.

Differences from My Product:

My product consists of no roller ball dispensing mechanism. A roller ball mechanism could not be used to dispense food products, like dips. It is more appropriately used to apply liquids or gels to a surface.

My product also does not contain any threaded channel with an aperture extending through it i.e. a screw based operation which requires penetration of the product itself providing no sealing for liquids, which would also get in the way of any “scooping” of the product out of the container.

Instead my product works with a spring, providing the linear motion of the product inside the housing container by gradual exposure of the spring to the bottom portion of the container directly underneath the platform. The product will also be able to be “scooped” out of my container from the top, not rubbed on anything using a roller ball where the product must come in contact with this roller ball in order for it to be applied elsewhere.

3. Patent on a butter dispenser with a bottom that moves with a screw mechanism:

U.S. Pat. No. 4,544,083: Butter Dispenser

Filing Date: Mar. 30, 1984

Patent Assignee: none

http://patft1.uspto.gov/netacgi/nph-Parser?patentnumber=4544083

### Abstract

In a butter dispenser having a hollow body for receiving a stick of butter and having a closure member at one end, a selectively, rotatable shaft is provided having first a bearing surface for rotating freely within the hole in the closure member, a threaded plug for engaging the threads in the closure member and causing the shaft to be removed through the hole in the closure member when the shaft is rotated in a first direction, and having the remainder of the shaft threaded in a second direction to provide a rotating screw drive force against a piston arranged for travel along this remaining portion of the shaft when the shaft is rotated in a second direction.

Differences from My Product:

The Turn Up contains no screw mechanism or threaded plug as this does not provide a watertight seal between the upper side of the platform and the lower side of the container. There is no threaded shaft to rotate about or any screw drive force within my invention. The spring is what provides the motion and is gradually exposed therefore there is never any protruding shaft, screw, etc. also allowing for complete sealing of the platform within the container. Also with a threaded shaft in 2 direction this cannot lie flat on a surface during operation.

4. Patent on a food dispenser whose mechanism includes a spring.

U.S. Pat. No. 6,026,985: Food Dispenser Gun

Filing Date: Sep. 28, 1994

Patent Assignee: Robot-Coupe USA (Jackson, Miss.)

http://patft1.uspto.gov/netacgi/nph-Parser?patentnumber=6026985

### Abstract

A food dispenser gun, comprising a tube holding a quantity of an extrudable food product, a piston sealingly engaged with an interior of the tube, a rod coupled to the piston and an incremental dispenser engaged with the rod and the tube, the incremental dispenser comprising a trigger, or an advancement lever operable to move the rod in a first direction relative to the incremental dispenser in response to the trigger and a retrograde lock operable to prevent the rod from moving in a second direction, wherein the advancement lever and the retrograde lock are completely enclosed by a housing of the incremental dispenser. Other systems, devices and methods are disclosed.

Differences from My Product:

Movement is allowed in this product by a rod coupled to a piston where the rod is protruding completely in the opposite direction at first and allowed to push the product by a trigger operation. By the rod protruding in the opposite direction initially the gun cannot be placed flat on a surface with the dispensing end facing upwards. This is much like a caulk gun or grease gun. Also, the product would first need to be enclosed in a container where the bottom of this container can be simply pushed towards the top. This separate device would then push the bottom of that container, therefore dispensing the food product, such as in caulk containers or the push up ice cream treat etc. It requires a lot of material protruding initially in the opposite direction of motion, with an initially compressed conical compression spring there is almost no material protruding in the opposite direction of linear movement. The spring in this embodiment is located in the trigger mechanism, it does not affect the product moving linearly, it simply moves the trigger back to its initial position.

My product can be placed on any flat surface and dispense upwards, something the food dispenser gun cannot do because it has a rod protruding in the opposite direction from which the food is dispensed. With my invention idea the container needs no further mechanism allowing the inner cylinder to move upwards, it simply needs to be turned and the spring does all the linear work. This device is simply the dispensing gun which pushes a rod with a trigger, and further needs a separate container/cartridge with a bottom platform already enclosed.

5. Patent on the Original propel-repel type dispenser.

U.S. Pat. No. 4,298,036: Dispenser for stick solids

Filing Date: Dec. 13, 1979

Patent Assignee: Plastic Research Products, Inc.

http ://patft1.uspto.gov/netacgi/nph-Parser?patentnumber=4298036

### Abstract

An improved dispenser for cosmetic stick solids such as deodorants constructed to be filled in either normal or inverted position. This dispenser is cylindrical having walls of substantially uniform diameter, an open top, and substantially closed bottom. The dispenser is constructed so that the dispensing means is either pushed up manually, or propelled screw-mechanism. In the latter case, a long screw is mounted in a central opening in the bottom, and continues along the axis of the cylinder. The cap of the dispenser may assume either of two forms, a snap-on type, or a crew-on type, each exhibiting an air-tight seal. The snap-cap is constructed to include a plurality of cams which operate in conjunction with similar members on the mouth of the cylindrical container to provide relative ease in opening and closing the snap-cap. The dispenser is designed to be filled in a conventional manner from the opening in the top, or. Alternatively, from a hole in the bottom of the cylindrical container. In the latter case, an inside liner disposed between the cap and the mouth of the cylindrical container retain the product during the filling process.

Differences from My Product:

With my product there is no need to push up the product manually, the spring will do this through rotation.

My product also is not propelled by any screw type mechanism, as mentioned earlier a screw does not provide watertight sealing, so the container cannot be used with liquids. Furthermore; a screw mechanism would protrude all the way through the container to the top open end at all times, getting in the way of being able to dip products out of the container.

### JOURNAL AND PUBLICATIONS

6. Online instructions on how to convert deodorant container to food spreading device.

Butter Pen!

Instructables.com

Author(s)

http://www.instructables.com/id/butter-pen/

### Description

Instructions for converting a deodorant container into a butter spreading device. “Now you don't have to get a knife out to spread butter on toast, just use the butter pen!”

Differences from My Product:

This is simply a deodorant stick filled with butter instead of deodorant, and relies on screw based operation with a central shaft/screw type mechanism. This shaft protrudes through the center of the product which doesn't allow for a watertight seal between the platform and the container, also the shaft would get in the way of dipping chips into the container.

### MARKETING AND BUSINESS SEARCH

Relevant companies include the following:

7. Food gun manufacturer.

LEM Products (Harrison, Ohio)

Relevance: makes a food dispenser with a piston design

http://www.lemproducts.com/product/354/jerky_cannon_accessories
Differences from My Product:

This is merely a caulking gun like in product #4 The Food Dispensing gun converted to use beef jerky with, it requires a separate handle etc. from the cylinder and cannot lie flat atop a counter. It's mode of operation is enabled by a shaft.

### REFERENCES RELATED TO THIS TECHNOLOGY

(Note: Nothing has been found to be sealed or operate anything like “The Turn Up” where a spring provides linear motion through rotation.)
The following companies all manufacture many small plastic containers and dispensers:

1. Federal Package:
http://www.federalpackage.com/asp_pages/home.asp

2. Containers and Packaging supply:
http://www.containerandpackaging.com/itemtype.asp?gad=plastic_container&gclid=CM 7K8IeJ2aYCFaJ17AodChqS-w

3. Express Tubes:

http://www.expresstubes.com/

4. Judy's Soap and Creations:

http://www.soapandthings.com/showcategory.aspx?categoryid=38&resetfilter=true

5. Bramble Berry:
http://www.brambleberry.com/Lip-Balm-C89.aspx

6. SKS-Bottle:
http://www.sks-bottle.com/Lip_Balm/Lip_Balm.html

### BRIEF SUMMARY OF THE INVENTION

The Turn Up is a cylindrical upright container assembly used for dispensing food products, as the container is turned the inside contents move up. What makes The Turn Up so revolutionary is that through its unique design it's able to do this while maintaining a watertight seal inside the container. This unique design and sealing enables The Turn Up to be used with liquid based products such as salsa and dips.

The problem The Turn Up was designed to fix is experienced when the contents in a container get low. When the contents get low in a salsa container for instance, the salsa can no longer be scooped onto the chips easily. The salsa also tends to get it all over the consumer's hands when trying to scoop the salsa out. The same happens with peanut butter in a container when the contents get low. The Turn Up enables easier access to the contents in a container by bringing them up to the top of the container. This makes the product easily accessible as if having a full container. Containers with screw based linear movement have a screw through the middle of the entire container that the platform supporting the contents rides upon. The Turn Up has no material protruding above the platform enabling its watertight seal as well as an open area for scooping the contents out of the container.

### BRIEF DESCRIPTION OF THE SEVERAL VIEWS OF THE DRAWING

1/4 Initial Design—Turn Up Complete
This is the first design concept. This design features a cylindrical container assembly with a main housing, bottom housing, spring, platform/plunger, and lid.

FIG. 1A/4—Turn Up
This is the exploded view of the container assembly. In this view all parts are shown in their respective positions before assembly. When the container is assembled and the bottom and main housing are snapped together. The spring is contained between the two housings where its lower end is fixed and upper end is free inside of the main container. As the bottom is rotated and the main housing kept still the spring is gradually released into the main housing pushing up on the plunger, in turn moving whatever contents are contained in the container to the top. A separate lid is also included and used for storage.

FIG. 1B/4—Housing
The main housing shown in this design concept is a cylindrical container. However, the housing is not restricted to a cylindrical shape. This concept is shown as a hollow container with a closed bottom end and open top end, where the bottom end is offset from the end of the container. The bottom end features a small cutout, along the same track the spring will naturally use to enter into the container. The cutout will be big enough that the spring will fit through it effortlessly at all spring diameters. It also features a small circular cutout into the inner wall of the housing offset from the bottom edge. This circular cutout is less than half the wall thickness and is along the entire inner diameter of the main housing, just before the bottom end of the container, used for the bottom housing to snap into.
Any contents stored in this container will be contained within its open hollow top section. The Housing may be made of plastic for its stability, recyclability, and cost effectiveness, as well as for being non-toxic and safe for use with food products. It can also be made of cardboard, metal etc.

FIG. 1C/4—Bottom
The bottom housing shown in this design concept is a hollow cylinder with a closed flat bottom end and open top end, although it is not restricted to that shape. It features a small lip on the top outer edge of the housing. This lip fits into the circular cutout located on the main housings inside bottom section, used when they are snapped together. It also features a lip on the outside bottom section of the bottom housing which in this design is made to fit flush with the outside edges of the main housing when assembled. However, this lip may also be larger in diameter than the outside of the container if desired. There is also a small extrusion on the inside, located on the bottom which features a hole in it. This extrusion and hole are used for connection with the spring.
The bottom may be made of plastic for its stability, recyclability, and cost effectiveness, as well as for being non-toxic and safe for use with food products.

FIG. 1D/4—Spring
The spring used in this design concept is a conical compression spring with a smaller diameter top end and larger diameter bottom end.
The spring is placed into the open top end of the bottom housing during assembly. The bottom end of the spring is placed into the hole inside the bottom housing, restricting this end from rotation. The top end of the spring is placed into the small cutout in the bottom of the main housing and turned one revolution during assembly. The bottom and main housing are then snapped together, therefore completely compressing the spring while the unit is assembled. As the bottom and top are rotated separate from one another, the restriction at the bottom end of the spring forces the top end of the spring further into the body of the main housing. During rotation the springs potential energy is released as it is gradually uncompressed into the main housing, therefore pushing upwards.
The spring may be made of spring steel, plastic, or any other material desired.

FIG. 1E/4—Plunger/Platform
The platform is a flat, thin hollow cylinder with a closed top end and open bottom end, although it is not restricted to this shape. The platform is slightly larger in diameter than the diameter of the opening in the top of the main housing. This slight interference fit ensures the contents contained in the container cannot be exposed to the bottom end of the container and vice versa. At its initial position the platform lies at the bottom of the main housing atop the upper end of the spring.
The platform may be made of plastic for its stability, recyclability, and cost effectiveness, as well as for being non-toxic and safe for use with food products, or any other material desired.

FIG. 1F/4—Lid
The lid is cylindrical with an open bottom end and closed top end. It is significantly smaller in height than the main housing, with its inside walls just slightly smaller in diameter than the outside of the main housing. This interference fit ensures a tight seal so the lid may be used for storage purposes. The lid can also fit using a snap fit or screw on fitment depending upon the application.
The lid may be made of plastic for its stability, recyclability, and cost effectiveness, as well as for being non-toxic and safe for use with food products, or any other material desired.

FIG. 2A/4—Housing (2)
The main housing shown in this design concept is a cylindrical container. However, the housing is not restricted to a cylindrical shape. This concept is shown as a hollow container with a closed bottom end and open top end, where the bottom end is slightly offset from the end of the container. The bottom end features a small cutout, along the same track the spring will naturally use to enter into the container. The cutout will be big enough that the spring will fit through it effortlessly at all spring diameters. It also features a small circular cutout into the outer wall of the housing offset from the bottom edge. This circular cutout is less than half the wall thickness and is along the entire outer diameter of the main housing.
Any contents stored in this container will be contained within its open hollow top section. The Housing may be made of plastic for its stability, recyclability, and cost effectiveness, as well as for being non-toxic and safe for use with food products. It can also be made of cardboard, metal etc.

FIG. 2B/4—Bottom (2)
The bottom housing shown in this design concept is a hollow cylinder with a closed flat bottom end and open top end, although it is not restricted to that shape. It features a small lip on the top inner edge of the housing. This lip fits into the circular cutout located on the main housings bottom section, used when they are snapped together. It also features a lip on the outside bottom section of the bottom housing which in this design is made to be larger in diameter than the outside of the container if desired. There is also a small extrusion on the inside, located on the bottom which features a hole in it. This extrusion and hole are used for connection with the spring.
The bottom may be made of plastic for its stability, recyclability, and cost effectiveness, as well as for being non-toxic and safe for use with food products, or any other material desired.

FIG. 2C/4—Plunger/Platform (2)
The platform is a flat, thin hollow cylinder with a closed top end and open bottom end, although it is not restricted to this shape. The platform is slightly smaller in diameter than the diameter of the opening in the top of the main housing. It has an indentation around its entire outer diameter, resembling that of a half-moon. This half-moon indentation enables an o-ring to be placed around the platform for sealing. At its initial position the platform lies at the bottom of the main housing atop the upper end of the spring.
The platform may be made of plastic for its stability, recyclability, and cost effectiveness, as well as for being non-toxic and safe for use with food products, or any other material desired.

FIG. 2D/4—O-ring (2)

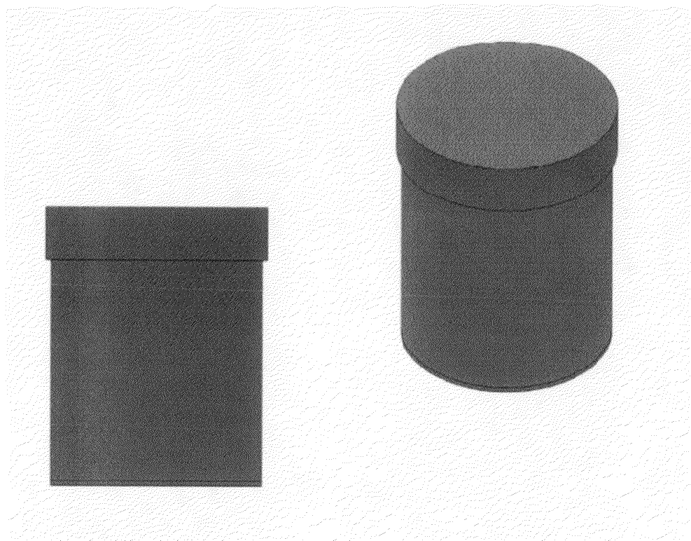

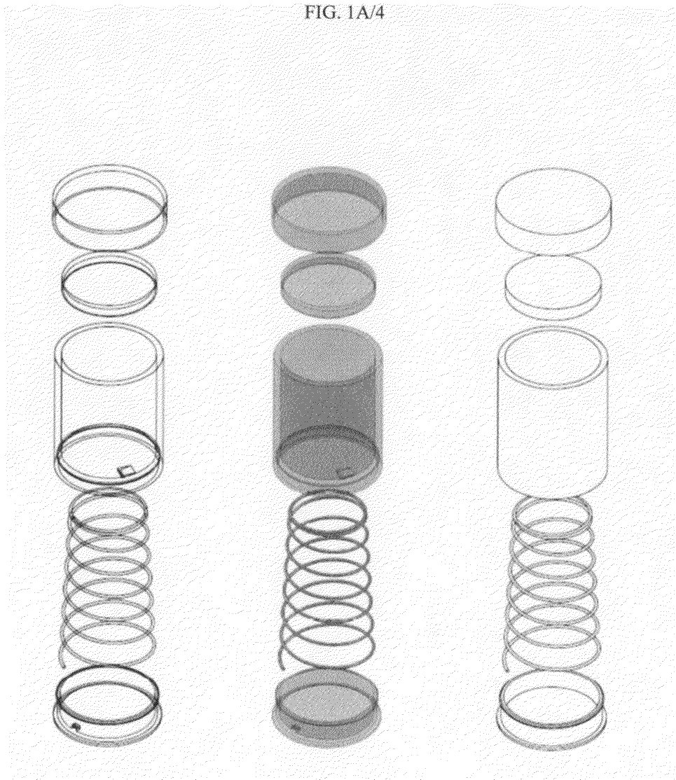

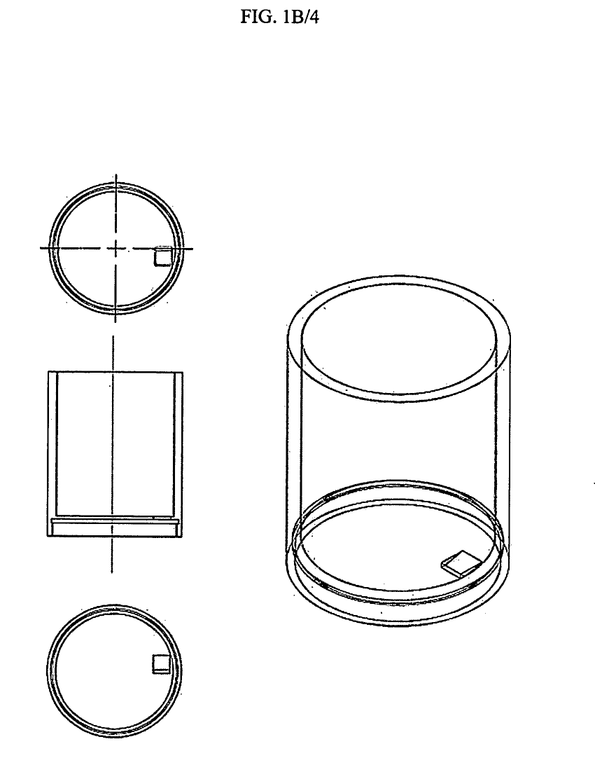

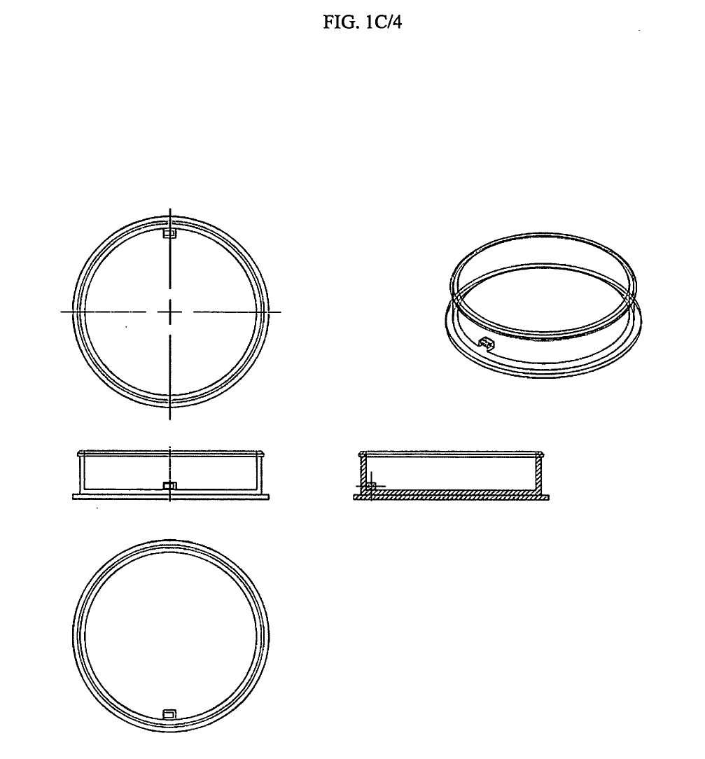

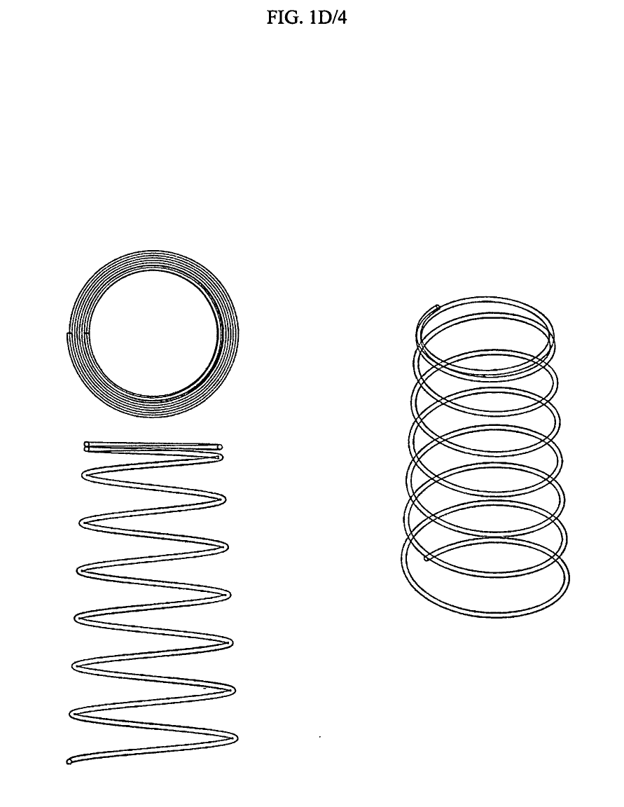

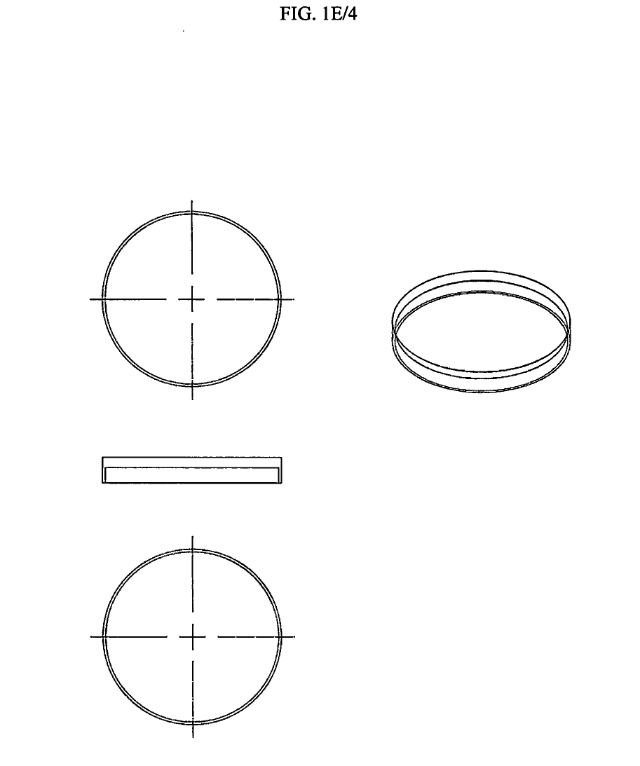

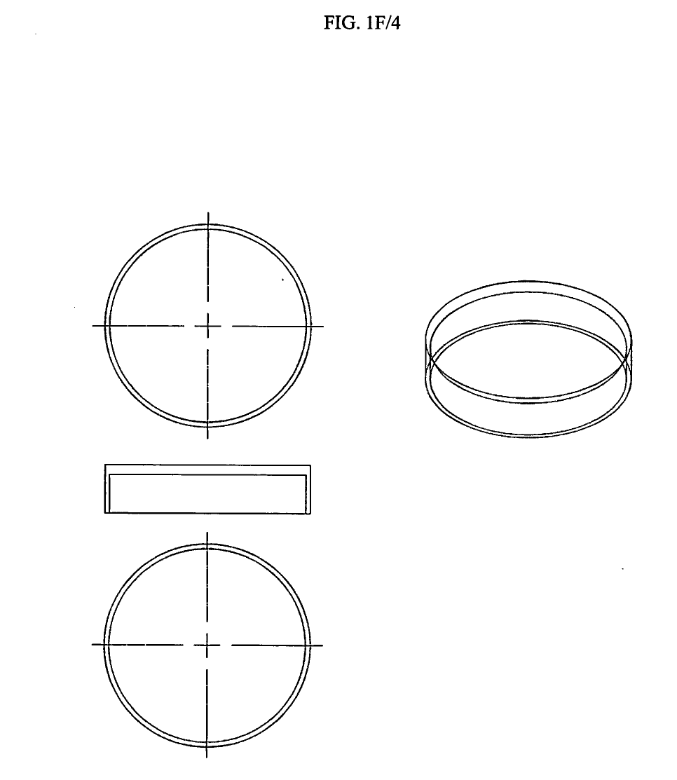

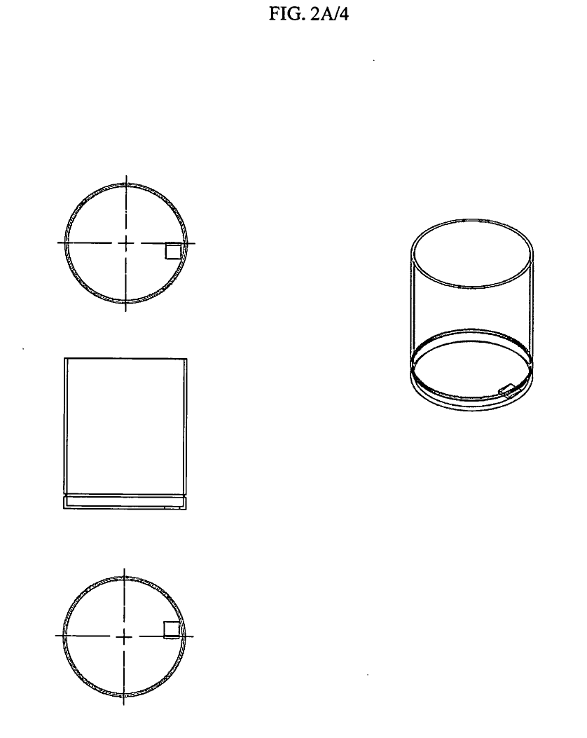

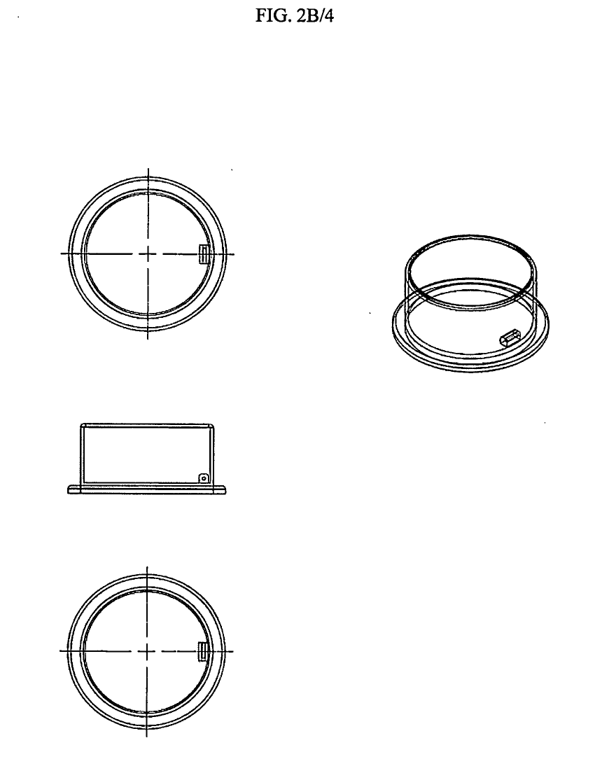

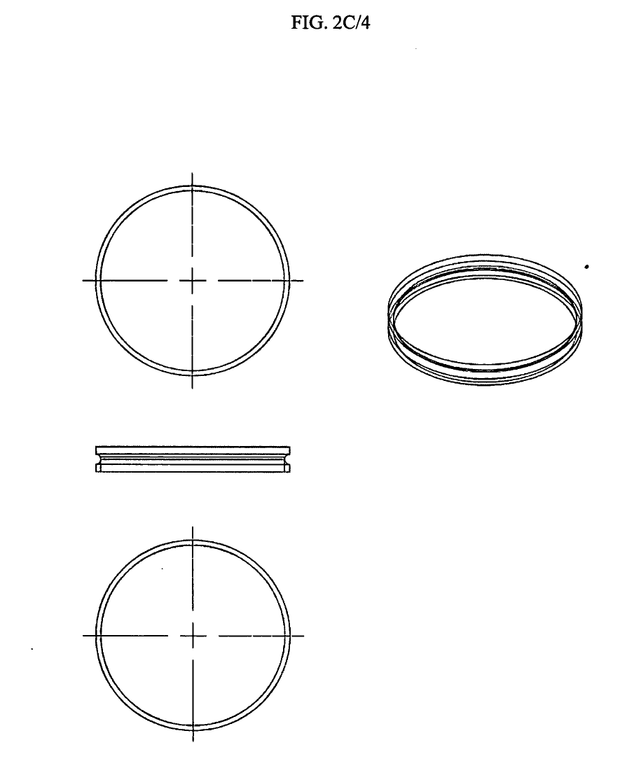

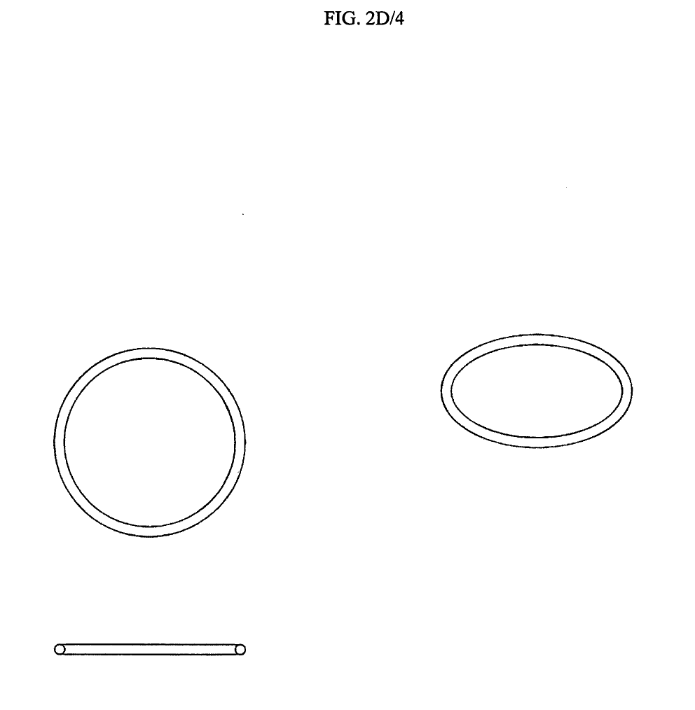

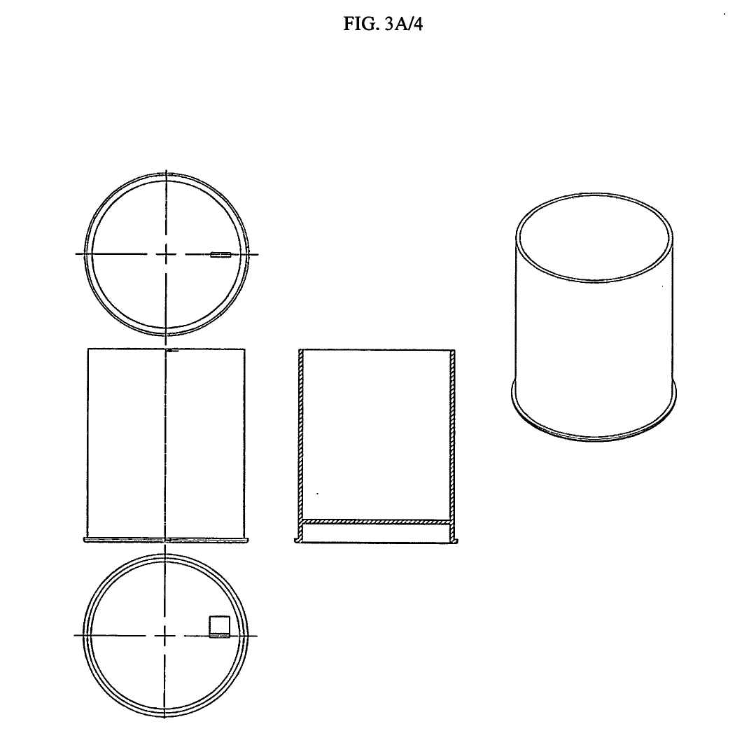

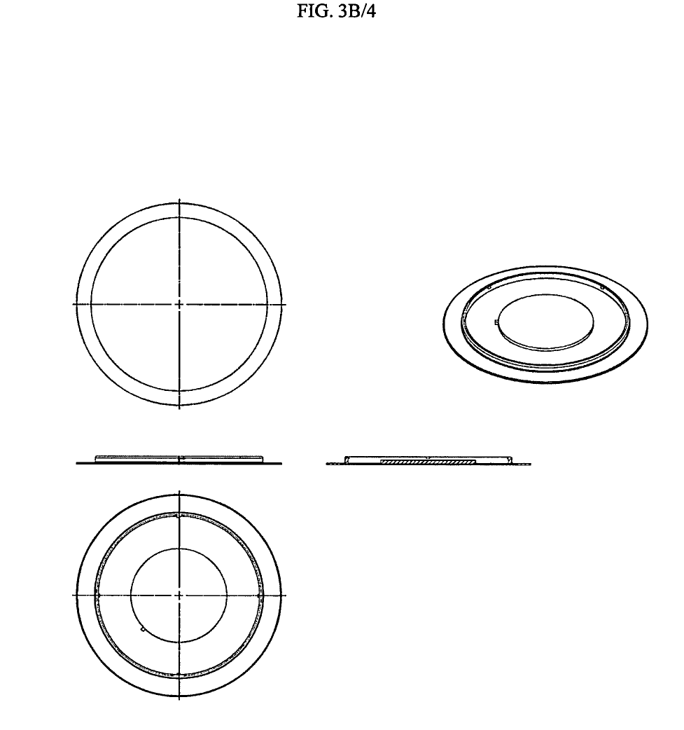

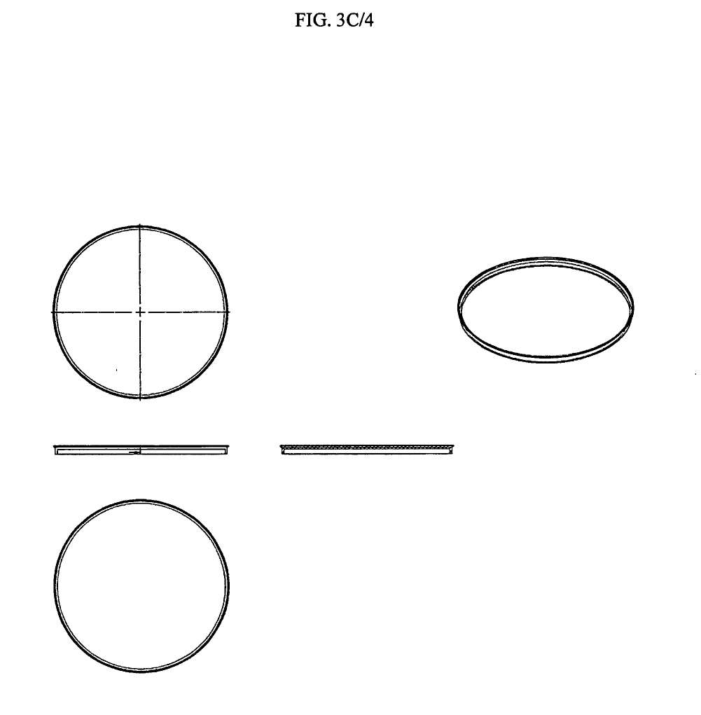

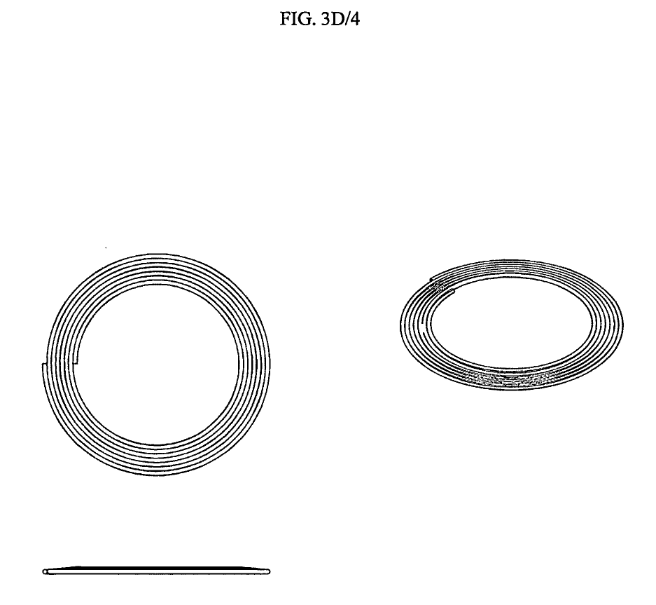

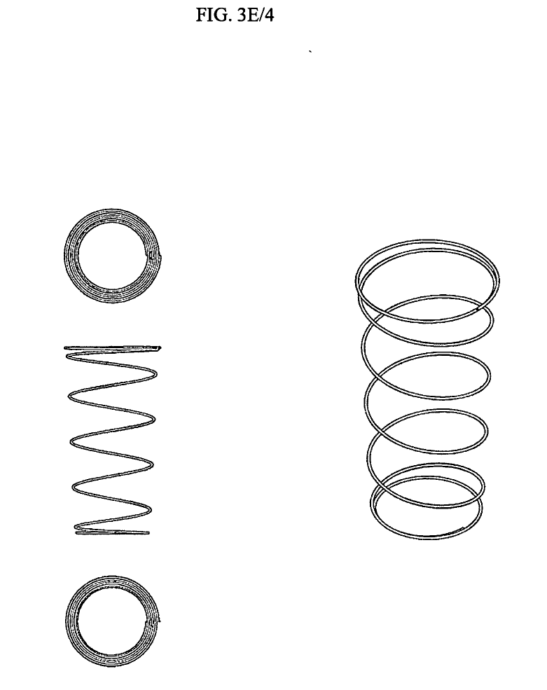

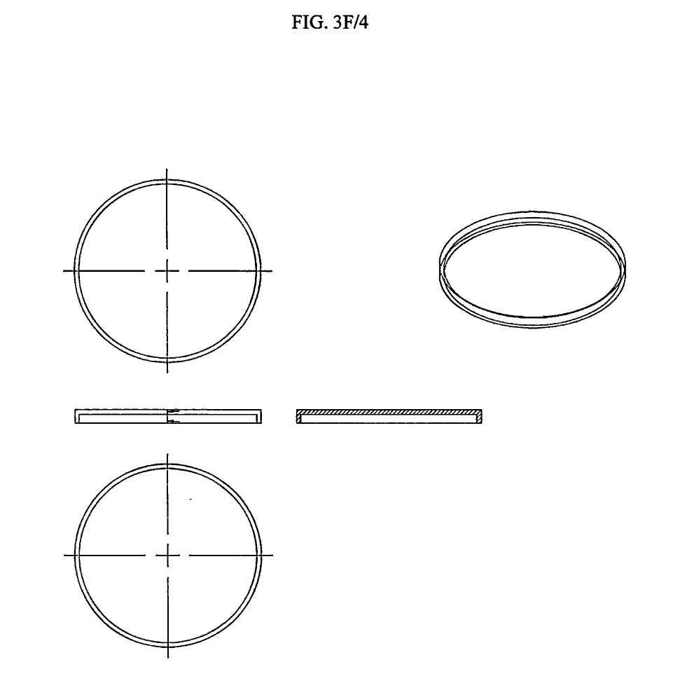

The inside diameter of this round o-ring is slightly smaller in diameter than the indentation around the platform, ensuring a snug fit. However, the outside diameter of this o-ring is slightly larger than the inside diameter of the main container housing. This slight interference fit ensures the contents contained in the container cannot be exposed to the bottom end of the container and vice versa, making for a watertight seal.

FIG. 3A/4—Housing (Container 2)
The main housing shown in this design concept is a cylindrical container. However, the housing is not restricted to a cylindrical shape. This concept is shown as a hollow container with a closed bottom end and open top end, where the bottom end is offset from the end of the container. The bottom end features a small cutout, along the same track the spring will naturally use to enter into the container. The cutout will be big enough that the spring will fit through it effortlessly at all spring diameters. It also features a small circular extrusion or ring along the outside wall of the housing on the bottom edge. This circular extrusion is along the entire outer diameter of the main housing.
Any contents stored in this container will be contained within its open hollow top section. The Housing may be made of plastic for its stability, recyclability, and cost effectiveness, as well as for being non-toxic and safe for use with food products. It can also be made of cardboard, metal etc.

FIG. 3B/4—Bottom (Container 2)
The bottom housing shown in this design concept is a flat, hollow cylinder with a closed flat bottom end and open top end, although it is not restricted to that shape. It features a small lip on the top inner edge of the housing at 4 points. These 4 points fit over the circular extrusion located on the main housings bottom edge, used when they are snapped together. It also features a lip on the outside bottom section of the bottom housing which in this design is made to be larger in diameter than the outside of the container. This lower lip enables the user to have better grip when restricting the bottom from moving while turning the main housing, best used whenever the container is upright on a surface. There is also a flat, round extrusion on the inside located in the center of the bottom inside face. This extrusion is slightly larger in diameter than the smallest diameter of the spring, causing an interference fit between the spring and the bottom extrusion. The extrusion also features another small extrusion at a 90 degree angle to its edge which restricts the spring from rotation.

FIG. 3C/4—Plunger/Platform (4)
The platform is a flat, thin hollow cylinder with a closed top end and open bottom end, although it is not restricted to this shape. The platform at its top edge is slightly larger in diameter than the diameter of the opening in the top of the main housing. The rest of the body is slightly smaller in diameter than the top edge, leading to a minimal friction surface, although maintaining a watertight seal. This slight interference fit ensures the contents contained in the container cannot be exposed to the bottom end of the container and vice versa. At its initial position the platform lies at the bottom of the main housing atop the upper end of the spring.
The platform may be made of plastic for its stability, recyclability, and cost effectiveness, as well as for being non-toxic and safe for use with food products, or any other material desired.

FIG. 3D/4—Spring Compressed (Container)
The conical compression spring is shown in this drawing in its fully compressed state. Allowing for a minimal solid height when fully compressed, allowing for the bottom housing to be as small and discreet as possible.

FIG. 3E/4—Spring (Container)
The conical compression spring is shown here with its smaller end at the bottom and larger end at the top. This upside down positioning will allow for the spring to have more stability inside the container below the plunger, as the largest part will be nearly the same diameter as the inner walls of the container and platform. The conical form will allow the spring's solid height to be as small as possible allowing for the base height to be minimal. Also with the conical spring the spring rate, pitch, and number of rotations can be varied depending on the product being used.
The material for the spring can be varied upon application but steel will most likely be used for its low cost and ease of manufacturing.

FIG. 3F/4—Lid (Container)
The lid is cylindrical with an open bottom end and closed top end. It is significantly smaller in height than the main housing, with its inside walls just slightly smaller in diameter than the outside of the main housing. This interference fit ensures a tight seal so the lid may be used for storage purposes. The lid can also fit using a snap fit or screw on fitment depending upon the application.
The lid may be made of plastic for its stability, recyclability, and cost effectiveness, as well as for being non-toxic and safe for use with food products, or any other material desired.

4/4—Prototype
The Turn Up: As seen in the picture, the product is an upright container that sits on the separate base it's connected to by a snap fit and a snap on lid contains any contents inside.

FIG. 4A/4—Prototype
In the above picture it can be seen that inside The Turn Up there is a platform which the desired filling substance rests upon. This platform retains the sealing between itself and the walls of the container at every position. As the container is turned this platform moves up bringing the contents closer to the top making it easier to gain access to them as well as providing a squeegee effect between the platform and the walls of the container, minimizing the amount of unused substance.

FIG. 4B/4—Prototype
In the picture above the platform is shown at its highest position which would be when the contents are completely used and the container is empty.

FIG. 4C/4—Prototype
The inner spring can be seen here completely exposed which would be the ending position when the platform would be at the highest point and the container is empty.

FIG. 4D/4—Prototype
The small hole in the bottom of the container can be seen here where the spring is gradually exposed from the base to the inside of the container through.

FIG. 4E/4—Prototype
The small hole is shown here when the spring is at its uppermost position and fully exposed within the container.

FIG. 4F/4—Prototype
The uncompressed spring is shown when it's initially inserted into the container.

FIG. 4G/4—Prototype
The base shown here is prototyped out of fiberglass where the container bottom lip fits within its housing by a snap fit providing a connection between the base and the container while allowing rotational movement.

FIG. 4H/4—Prototype
The main container here is shown in one of the cheapest forms, made of simple cardboard with a metal upper ring and metal bottom, which protrudes slightly from the cardboard sides creating a small metal lip.

FIG. 4I/4—Prototype
The conical compression spring is shown at its uncompressed position. In its completely compressed position the spring lies flat at a height closely equal to its diameter allowing for the base to be as small and discreet as possible. The spring shown here is made of steel.

FIG. 4J/4—Prototype
The small platform is shown here made of plastic. It is a slightly larger diameter than the inside of the container making an interference fit providing sealing with its edges as well as stability when in motion.

FIG. 4K/4—Prototype
The lid is shown above in plastic. It connects to the top of the container using a snap fit keeping the contents inside the container.

### DETAILED DESCRIPTION OF THE INVENTION

The container assembly's final chosen characteristics are described here which are also found on the prototype. The Turn Up is a cylindrical upright container assembly designed for easy dispensing of its contents. As the container is rotated about its vertical axis separate from the base it's connected to, the contents move up enabling easier access to them as they get low. The Turn Up was designed primarily to dispense food products such as dips and salsas, which is why the design is so unique. It can store and dispense liquid based products while maintaining a watertight seal. It dispenses any contained products through the open top end of the container which can be closed with a lid when the contents are not in use.

The container assembly consists of five parts: a main housing, bottom housing, platform, conical compression spring, and lid. The main housing is the container; this is where the contents are stored.

The container is a hollow cylinder with an open top end, and closed bottom end. The closed bottom end has a triangular cutout starting from its center, between 0 and 90 degrees (about ¼ of the circle) which is where the spring enters the container. The very bottom outside edge is slightly larger in diameter than the rest of the container, creating a small lip which protrudes just beyond the walls of the container.

The bottom housing is flat and circular with an open top end and closed bottom end. The bottom housing consists of two different inner diameters with one common outside diameter. One inner diameter is slightly smaller than the diameter of the small edge on the bottom of main housing; the other diameter is slightly larger. The smaller diameter begins at the top open edge of the housing, ending ¼^{th} of the way down. The larger diameter starts where the smaller diameter ends and proceeds down to the bottom of the housing. This difference in diameter enables the main housing container to be “snapped” onto the bottom housing for a secure connection, while also allowing rotation. On the inside bottom of the bottom housing there is an extrusion where the smaller end of the spring will be inserted. This extrusion restricts the spring end from movement during rotation of the housing. When connected, the spring will be contained between the two housings.

A platform is located inside the main housing container and rests initially at the bottom. The platform is flat and circular with a diameter slightly larger than the inside of the container. This creates an interference fit ensuring a watertight seal between the edges of the platform and the walls of the container.

The spring moves the platform from the bottom to the top of the container. The spring is a conical compression spring, which allows it to have a minimal solid height. Therefore when compressed, the spring is only as tall as the diameter of the wire it's made of This minimal solid height enables the bottom housing to be as small as possible. The larger diameter end of the spring is nearly the same diameter as the inside of the main housing; this allows maximum stability of the spring inside of the container. The larger diameter end is initially placed into the small cutout on the bottom of the main container, and then turned one revolution; where it then lies between the platform and the bottom of the main container. The spring's smaller diameter end is then fixed to the small extrusion in the bottom housing. Once the bottom housing is snapped onto the small lip on the outside bottom of the main container the majority of the spring is compressed between the outside bottom of the main container and the inside bottom of the bottom housing.

A lid can also be used when the contents are not in use. The lid covers the open top end of the main container and can either be screw on or snap on type depending on the product being stored.

Once the container is assembled the bottom end can simply be rotated and the contents move up. Since the bottom end of the spring is fixed to the bottom housing, when the bottom housing is rotated the spring is gradually forced further into the main container. This causes the spring to uncompress gradually into the main container, therefore releasing its potential energy, causing the plunger to move upwards. The Turn Up provides liner motion of the platform along its vertical axis as a result of the rotation of the container. This is done without penetration of the upper surface of the platform which is why it can maintain a watertight seal between the contents and lower part of the container at all times.

The container and all of its components can be made of various materials, all which are 100 percent recyclable. The manufacturing processes that would most appropriately apply to The Turn Up would be plastic injection molding. If the container is made of a cardboard with a metal top and bottom as in the prototype then the top and bottom will most likely be punched and the cardboard rolled. If the spring is wished to be made of spring steel coiling would be the best process for manufacturing the spring.

Simple machine automation assembly of The Turn Up would be appropriate. The spring could be attached to the base by the interference fit between the smallest coil of the spring and the round extrusion on the inside of the base. The spring's large end could then be inserted into the small hole at the bottom of the main container and turned one revolution allowing for proper initial guidance. The base could then be snapped together with the main container and the platform inserted into the main container atop the spring. Once the bottom housing, spring, main container and platform are assembled the container can be filled with the desired contents and a lid attached.

The Turn Up will be used primarily for dispensing food dips such as salsa, queso, ranch, guacamole, bean dip, etc. It can also be used for condiments like peanut butter, jelly, mayonnaise and so on. However it is not limited to food products. The Turn Up can even be used for household or industrial products such as petroleum jelly, paint, or even grease. Also if the top is closed off it may be used to compress the inside cylinder wherever this might have mechanical utilization.

All existing containers which move a product upward during use are not able to store liquid products. These products include lip balm containers, glue stick containers, etc. All of these existing containers either utilize a screw based mode of operation or a track mode of operation, neither of which are watertight. With screw based operation, a center screw moves a platform upwards. This screw gets in the way of trying to scoop the contents out of the container since it must protrude nearly to the top of the container. With the track type this track is usually located along the inner walls of the container, where the platform follows this track to the top. However, the track would get clogged whenever a substance is used that isn't completely solid.

My intention for this container is for it to be made as cost effectively as possible where it can be the new container for products such as dips and condiments. Due to the construction and materials of The Turn Up, it will be 100 percent recyclable and reusable if desired. Many forms can be made with different shapes, sizes, and materials. The Turn Up can be sold for specific or general applications. The product can be branded by companies with their own label, colors, etc.

There is analysis needed for the container to be specific to particular applications. This analysis would be performed on things such as material selection as well as between the fitments of particular parts of the assembly. The particular fitments that would have to be analyzed would be between the snap fit of the container and the base, the lid and the container, the interference fit between the spring and the base, and the diameter of the platform with the inside of the container. The angle of the hole and the pitch, revolutions, and diameter of the spring as well as the spring rate would also have to be adjusted accordingly. The spring force would need to be calculated depending upon the contents density, texture etc.

My ideal process for manufacturing and selling The Turn Up would be to first have my prototype analyzed, engineered, and tailored according to a specific products needs. This specific product will be determined by the company that shows the most interest in The Turn Up. The size of the entire assembly will be dependent upon the product being stored, which will also determine the stiffness of the spring. I plan to have a mold made for the plastic injection molding of the desired plastic components, and the spring coiled. Once The Turn Up is made to a certain specification, the label of the contained product may be used on the outside of the container and The Turn Up sold wherever desired.

Ideally, I would love for The Turn Up to be the new container for salsa and dips worldwide.

I thought of this idea in college while I was eating chips and salsa and couldn't keep from getting the salsa on my hands. I'm a recent graduate of Mechanical Engineering at The University of Florida in Gainesville, Florida and I am deciding to pursue a non provisional utility patent for the idea in hopes of mass production.

I claim:

1. A container assembly comprising an initially compressed spring, which is gradually released by rotation and used for linear movement of its contents.

2. A containment device which dispenses its contents by utilizing the gradual release of a spring's potential energy, achieved by turning the spring, in order to provide linear movement.

3. A food container comprising a compression spring used for linear movement of its contents.
